(19) United States
(12) Patent Application Publication
(10) Pub. No.: US 2023/0314569 A1
(43) Pub. Date: Oct. 5, 2023

(54) DISTANCE SENSING MODULE

(71) Applicant: Egis Technology Inc., Hsinchu City (TW)

(72) Inventor: Chen-Wei Fan, Hsinchu City (TW)

(73) Assignee: Egis Technology Inc., Hsinchu City (TW)

(21) Appl. No.: 18/172,335

(22) Filed: Feb. 22, 2023

Related U.S. Application Data
(60) Provisional application No. 63/325,142, filed on Mar. 29, 2022.

(30) Foreign Application Priority Data
Dec. 7, 2022 (TW) 111146867

(51) Int. Cl. G01S 7/481; G01S 13/08

(52) U.S. Cl. CPC G01S 7/4813; G01S 7/4816; G01S 13/08

(57) ABSTRACT

A distance sensing module includes a first substrate, an upper cover, a light-emitting unit, and at least one sensing pixel. The upper cover is disposed on the first substrate to form an accommodating space. The light-emitting unit is disposed at an emitting end in the accommodating space. The sensing pixel is disposed at a receiving end in the accommodating space and includes a second substrate disposed in the accommodating space and having a top surface, sensing areas disposed in the second substrate and exposed on the top surface, a light guide layer including light guide structures having first sides connected to a light transmission layer and second sides coupled to the sensing areas, a lens layer including at least one lens, and the light transmission layer between the light guide layer and the lens layer. The light guide layer is between the second substrate and the light transmission layer.

### CROSS-REFERENCE TO RELATED APPLICATION

This application claims the priority benefit of U.S. provisional application Ser. No. 63/325,142, filed on Mar. 29, 2022, and Taiwan application serial no. 111146867, filed on Dec. 7, 2022. The entirety of each of the above-mentioned patent applications is hereby incorporated by reference herein and made a part of this specification.

### BACKGROUND OF THE INVENTION

### Field of the Invention

The invention relates to an electronic device, and in particular to a distance sensing module.

### Description of Related Art

In the current application of distance sensing techniques, from long-distance remote sensing landform detection to medium-distance factory automation unmanned trucks, smart machines, vehicle-assisted driving, or unmanned vehicles, drones, etc., and to short-distance applications including sweeping robots, gesture recognition devices and face recognition systems for mobile phones are extremely widespread and ubiquitous. The rapid development in recent years is mainly driven by the application of this technology in consumer goods and automotive electronics. A Time of Flight (ToF) sensing device is often used in the application of general distance sensing techniques. The distance between the sensing device and the object to be measured is calculated by calculating the time difference or phase difference between the sensing device emitting the light source and receiving the light source being reflected back.

In the ToF sensing device, a plurality of sensing pixels may be configured as sensing units. However, for the sensing element of the ToF sensing device, only light incident on the sensing areas is absorbed by silicon, but since the sensing areas only occupy a portion of the sensing element, the overall light collection efficiency is poor. In the current architecture, a giant microlens (GML) may be used to first condense the light to be transmitted to a photosensitive element, thereby increasing effective fill factor. However, after the light spot is focused by the GML, a portion of the light spot still falls outside the sensing areas, resulting in low light collection efficiency.

### SUMMARY OF THE INVENTION

The invention provides a distance sensing module that may increase light collection efficiency when a receiving end receives a sensing light, thereby improving distance sensing effect.

The invention provides a distance sensing module including a first substrate, an upper cover, a light-emitting unit, and at least one sensing pixel. The upper cover is disposed on the first substrate to form an accommodating space. The light-emitting unit is disposed at an emitting end in the accommodating space. The at least one sensing pixel is disposed at a receiving end in the accommodating space. The sensing pixel includes a second substrate, a plurality of sensing areas, a light guide layer, a light transmission layer, and a lens layer. The second substrate is disposed in the accommodating space and has a top surface. The plurality of sensing areas are disposed in the second substrate and exposed on the top surface. The light guide layer is disposed on the second substrate, wherein the light guide layer includes a plurality of light guide structures, and each of the plurality of light guide structures has a first side and a second side opposite to each other. The plurality of second sides are coupled to the plurality of sensing areas. The light transmission layer is disposed on the light guide layer. The light guide layer is located between the second substrate and the light transmission layer, and the plurality of first sides are connected to the light transmission layer. The lens layer includes at least one lens disposed on the light transmission layer. The transmission layer is located between the light guide layer and the lens layer.

Based on the above, in the distance sensing module of the invention, the emitting end of the distance sensing module includes the light-emitting unit and the at least one sensing pixel at the receiving end. In particular, the sensing pixel includes the second substrate, the plurality of sensing areas, the light guide layer, the light transmission layer, and the lens layer. The light guide layer includes the plurality of light guide structures, so that when the sensing light is transmitted to the plurality of light guide structures in the light guide layer, the sensing light may be gathered on the sensing areas via the principle of total reflection, thus further reducing the loss of the sensing light. In this way, the amount of received light may be increased to improve the efficiency of use of the sensing light, thereby improving the sensing effect of the distance sensing module.

In order to make the aforementioned features and advantages of the disclosure more comprehensible, embodiments accompanied with figures are described in detail below.

### BRIEF DESCRIPTION OF THE DRAWINGS

FIG. 1 is a schematic cross-sectional view of a distance sensing module of an embodiment of the invention.

FIG. 2 is a schematic top view of a receiving end of the distance sensing module in FIG. 1.

FIG. 3 is a schematic cross-sectional view of a sensing pixel of an embodiment of the invention.

FIG. 4 is a three-dimensional schematic diagram of a light guide structure of an embodiment of the invention.

FIG. 5 is a schematic cross-sectional view of a sensing pixel of another embodiment of the invention.

FIG. 6 is a schematic cross-sectional view of a sensing pixel of another embodiment of the invention.

FIG. 7 is a schematic cross-sectional view of a sensing pixel of another embodiment of the invention.

FIG. 8A is a schematic cross-sectional view of a sensing pixel of another embodiment of the invention.

FIG. 8B is a schematic cross-sectional view of a sensing pixel of another embodiment of the invention.

FIG. 9 is a schematic cross-sectional view of a sensing pixel of another embodiment of the invention.

FIG. 10 is a schematic cross-sectional view of a sensing pixel of another embodiment of the invention.

FIG. 11 is a schematic cross-sectional view of a sensing pixel of another embodiment of the invention.

FIG. 12A and FIG. 12B are respectively schematic cross-sectional views of light guide structures of different embodiments of the invention.

### DESCRIPTION OF THE EMBODIMENTS

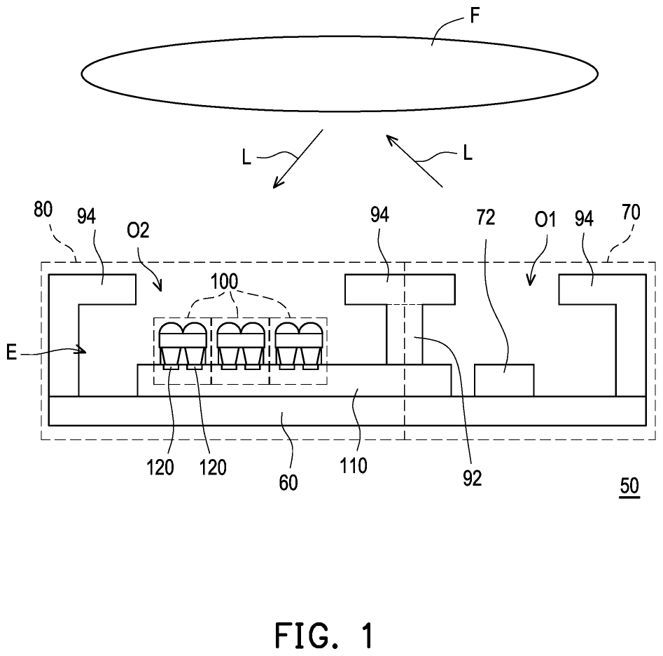

FIG. 1 is a schematic cross-sectional view of a distance sensing module of an embodiment of the invention. For the convenience of description, the number and size of the elements shown in FIG. 1 are only schematic. Please refer to FIG. 1. A distance sensing module 50 is configured to emit light to irradiate a target F to be sensed and to sense the light reflected from the target F to be sensed, and the distance between the distance sensing module 50 and the target F to be sensed is measured by calculating the time of flight (ToF) of the light. The present embodiment provides the distance sensing module 50 including a first substrate 60, an upper cover 94, a light-emitting unit 72, and at least one sensing pixel 100. In particular, the upper cover 94 is disposed on the first substrate 60 to form an accommodating space E, wherein the accommodating space E has an emitting end 70 and a receiving end 80. The light-emitting unit 72 is disposed at the emitting end 70, and the at least one sensing pixel 100 is disposed at the receiving end 80. The emitting end 70 is configured to provide a sensing light L (that is, provided by the light-emitting unit 72, and the number of the light-emitting unit 72 in the emitting end 70 is not limited in the invention) to the target F to be sensed (such as a finger), and the receiving end 80 is configured to receive the sensing light L reflected by the target F to be sensed for analysis.

In the present embodiment, the distance sensing module 50 further includes a baffle 92, and the sensing pixel 100 includes a second substrate 110. The second substrate 110 is disposed in the accommodating space E and electrically connected to the first substrate 60. The material of the second substrate 110 is, for example, silicon (Si), and has a top surface S1, and the top surface S1 is the surface of the second substrate 110 away from the first substrate 60. The baffle 92 is disposed in the accommodating space E and connected to the upper cover 94 and configured to partition the accommodating space E into the emitting end 70 and the receiving end 80. Moreover, the upper cover 94 has windows O1 and O2 respectively corresponding to the emitting end 70 and the receiving end 80. The light emitted by the light-emitting unit 72 is emitted to the target F to be sensed via the window O1, and the light reflected from the target F to be sensed enters the receiving end 80 via the window O2. In addition, the baffle 92 may be integrally formed with the upper cover 94 or formed separately, and the invention is not limited thereto.

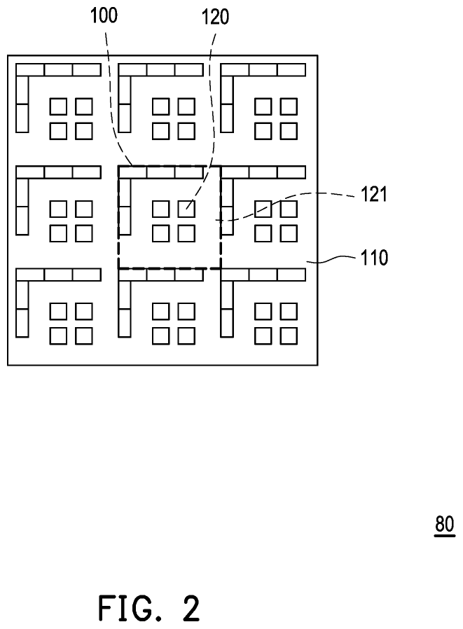

FIG. 2 is a schematic top view of the receiving end of the distance sensing module in FIG. 1. Please refer to FIG. 1 and FIG. 2 at the same time. The sensing pixel 100 shown in the present embodiment may be applied to the receiving end 80 shown in FIG. 1, wherein the number of the sensing pixel 100 in the receiving end 80 may be single or multiple, and the invention is not limited thereto. The description below takes a plurality of sensing pixels 100 as an example. The plurality of sensing pixels 100 of the receiving end 80 may be arranged in an array. For example, the sensing pixels 100 may be arranged in a 3×3 array and share the second substrate 110, but the invention does not limit the arrangement method of the sensing pixels 100. In addition, each of the sensing pixels 100 may include a sensing area 120 and a non-sensing area 121 located around the sensing area 120. As shown in FIG. 2, each of the sensing pixels 100 may include four sensing areas 120 arranged in a 2×2 array. There may be gaps (i.e., the non-sensing areas 121) between the sensing areas 120, and the sensing areas 120 are configured to sense a light signal. The non-sensing areas 121 may include a circuit area configured to read the light signal sensed by the sensing areas 120 and a clear area around the sensing areas 120. Therefore, the array formed by the sensing areas 120 is not necessarily center-aligned with the sensing pixels 100, and the area of the array of sensing areas 120 may also be less than the area of the sensing pixels 100. That is, the sensing areas 120 may form a dislocation configuration with other members (such as lenses) in the sensing pixels 100. The specific structure of the sensing pixels 100 is described in more detail in the following paragraphs.

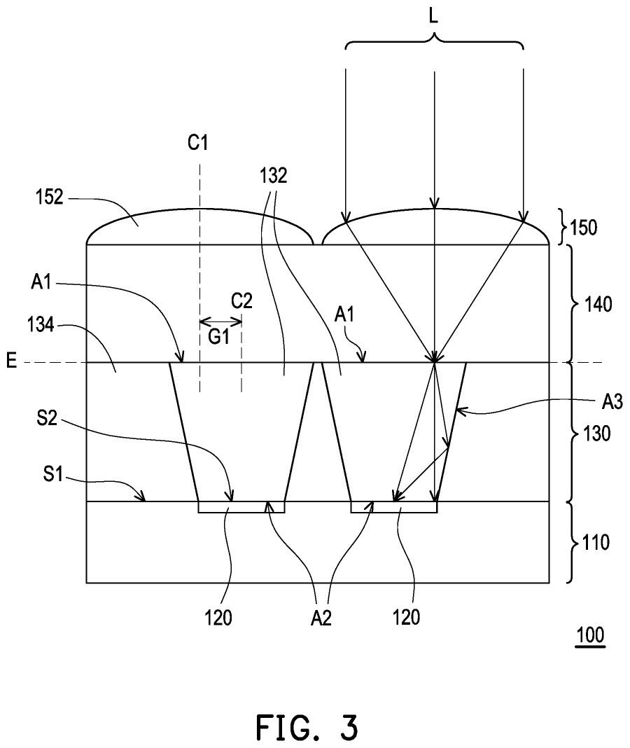

FIG. 3 is a schematic cross-sectional view of a sensing pixel of an embodiment of the invention. Please refer to FIG. 1 and FIG. 3. In the present embodiment, the sensing pixels 100 include the second substrate 110, the plurality of sensing areas 120, a light guide layer 130, a light transmission layer 140, and a lens layer 150. It is worth mentioning that, in the present embodiment, the number of the sensing pixels 100 is multiple, the sensing pixels 100 are disposed at the receiving end 80 of the distance sensing module 50, and the plurality of sensing pixels 100 share the same second substrate 110, as shown in FIG. 1. The plurality of sensing areas 120 of each of the sensing pixels 100 are disposed in the second substrate 110 and exposed on the top surface S1 of the second substrate 110, but the invention is not limited thereto. The sensing areas 120 of the present example are arranged in a 2×2 array, and FIG. 3 shows two of the sensing areas 120. Specifically, each of the sensing areas 120 has an incident surface S2, and the incident surface S2 and the top surface S1 of the second substrate 110 may be coplanar. In addition, as shown in FIG. 1, the second substrate 110 may be extended from the receiving end 80 in the accommodating space E to the emitting end 70, and a reference light-sensing element (not shown) may be disposed on the second substrate 110 of the emitting end 70 and configured to perform additional sensing on the sensing light L provided by the light-emitting unit 72 at the emitting end 70 to facilitate subsequent distance calculation.

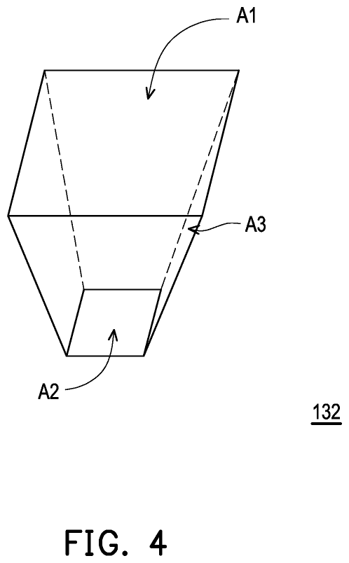

FIG. 4 is a three-dimensional schematic diagram of a light guide structure of an embodiment of the invention. Please refer to FIG. 3 and FIG. 4. The light guide layer 130 is disposed between the second substrate 110 and the light transmission layer 140, wherein the light guide layer 130 includes a plurality of light guide structures 132, and the material thereof is, for example, nitride, phosphide, arsenide, and the like. Each of the light guide structures 132 has a first side A1 and a second side A2 opposite to each other, the first side A1 of each of the light guide structures 132 is connected to the light transmission layer 140, and the second side A2 of each of the light guide structures 132 is coupled to the plurality of sensing areas 120. In other words, the first side A1 of each of the light guide structures 132 is coplanar at the junction of the light guide layer 130 and the light transmission layer 140, the second side A2 of each of the light guide structures 132 is coplanar at the junction of the light guide layer 130 and the second substrate 110, and the orthographic projection of the second side A2 is completely overlapped with the incident surface S2 of the corresponding sensing area 120. Specifically, each of the light guide structures 132 also has a sidewall A3 connected to and surrounding between the first side A1 and the second side A2. In the present embodiment, as shown in FIG. 4, the area of the first side A1 is greater than the area of the second side A2, and the orthographic projection of the second side A2 on the second substrate 110 is completely overlapped with the orthographic projection of the first side A1 on the second substrate 110. Furthermore, the center of the orthographic projection of the second side A2 on the second substrate 110 is aligned with the center of the orthographic projection of the first side A1 on the second substrate 110, that is, the first side A1 and the second side A2 are center-aligned. For example, in the present embodiment, the shape of the plurality of light guide structures 132 is a frustum polygonal pyramid, such as a square column as shown in the figure. However, in a different embodiment, the shape of the plurality of light guide structures 132 may also be designed as a hexagonal column/cone, an octagonal column/cone, or a cylinder/cone such as a frustum cone, and the invention is not limited thereto.

Please refer to FIG. 3 again, specifically, the light guide layer 130 further includes a medium structure 134, and the material thereof is, for example, oxide. The medium structure 134 surrounds the plurality of light guide structures 132 in the light guide layer 130. In particular, the refractive index of the light guide structures 132 is greater than the refractive index of the medium structure 134. Specifically, in the present embodiment, when the light-emitting unit 72 emits light with a wavelength of 940 nm, the refractive index of the light guide structures 132 is, for example, 1.9, and the refractive index of the medium structure 134 is, for example, 1.45. When the light-emitting unit 72 emits light of different wavebands, the refractive indices of the light guide structures 132 and the medium structure 134 are slightly different accordingly. For example, when the light-emitting unit 72 emits light of 550 nm, the refractive indices of the light guide structures 132 and the medium structure 134 are, for example, 1.92 and 1.46, respectively, but the invention is not limited thereto. Since the refractive index of the light guide structures 132 is greater than that of the medium structure 134, the light entering the light guide layer 130 is guided by the light guide structures 132 to be transmitted from the first side A1 to the second side A2 and then incident on the sensing areas 120. In particular, in the sensing light passing through the first side A1, a portion does not touch the sidewall A3 and directly enters the sensing areas 120 via the second side A2, and after another portion is transmitted to the sidewall A3, since the refractive index of the light guide structures 132 is greater than that of the medium structure outside the sidewall A3, the sensing light is totally reflected from the sidewall A3 to the second side A2 to enter the sensing areas 120. In the present embodiment, the positions and number of the plurality of light guide structures 132 correspond to the plurality of sensing areas 120.

The light transmission layer 140 is made of a light transmission material, such as silicon dioxide (SiO₂), silicon nitride (SiN), resin polymer, or photoresist, and the refractive index thereof is, for example, 1.52. The light transmission layer 140 is disposed between the light guide layer 130 and the lens layer 150, and may be used as a bonding medium between the lens layer 150 and the light guide layer 130 to firmly connect the light guide layer 130 and the lens layer 150. The lens layer 150 includes at least one lens 152 disposed on the light transmission layer 140. In the present embodiment, the number of the lens 152 in the lens layer 150 is multiple, wherein the number of the lenses 152 is the same as the number of the sensing areas 120 in the sensing pixels 100, and the positions of the lenses 152 correspond to the plurality of light guide structures 132. Moreover, in the present embodiment, focal planes E of the lenses 152 are overlapped with the first sides A1 of the light guide structures 132, and there is spacing G1 between a centerline C1 of each of the plurality of lenses 152 and a centerline C2 of each of the plurality of first sides A1. In particular, the thickness of the light transmission layer 140 may be designed according to the focal length of the lenses 152 so that the focal planes E of the lenses 152 are overlapped with the first sides A1 of the light guide structures 132. In addition, the so-called centerlines C1 and C2 are imaginary lines passing through the center points of the lenses 152 and the first sides A1 and perpendicular to the horizontal direction respectively. In other words, the lenses 152 and the corresponding light guide structures 132 present an off-axis design: the geometric center of the orthographic projection of the lenses 152 on the second substrate 110 is not overlapped with the geometric center of the orthographic projection of the corresponding first sides A1 on the second substrate 110; that is, the lenses 152 are not center-aligned with the first sides A1. It is worth mentioning that, since the first sides A1, the second sides A2, and the sensing areas 120 are center-aligned in the present embodiment, and the lenses 152 are not center-aligned with the first sides A1, the lenses 152 are also not center-aligned with the second sides A2 and the sensing areas 120.

Therefore, when the sensing light L emerges from the emitting end 70, is reflected to the receiving end 80 via the target F to be sensed, and then enters the sensing pixels 100, the sensing light L is transmitted to the corresponding sensing areas 120 sequentially by the lens layer 150, the light transmission layer 140, and the light guide layer 130. In particular, when the sensing light L is transmitted to the light guide layer 130, the sensing light L entering the light guide structures 132 within the range of the first sides A1 may be reflected to the sensing areas 120 corresponding to the second sides A2 via the sidewalls A3 by total reflection, thereby reducing the loss of the sensing light L. In this way, since the sensing areas 120 are not center-aligned with the lenses 152, a portion of the converged sensing light L that would not have been incident on the sensing areas 120 without the light guide structure 132 may now be incident on the sensing areas 120 by the guidance of the light guide structures 132 to increase light collection efficiency and thereby improve the sensing effect of the sensing pixels 100.

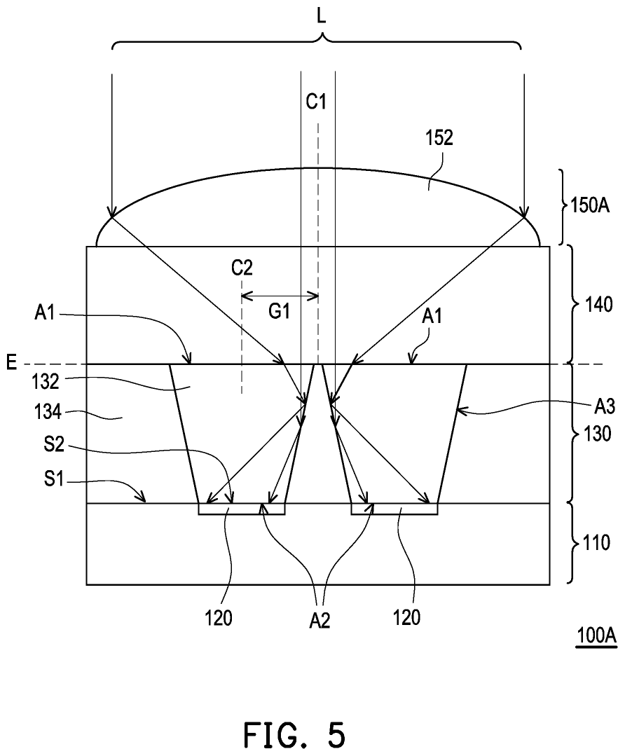

FIG. 5 is a schematic cross-sectional view of a sensing pixel of another embodiment of the invention. Please refer to FIG. 5. A sensing pixel 100A of the present embodiment is similar to the sensing pixel 100 shown in FIG. 3. The difference between the two is that in the present embodiment, the number of the sensing areas 120 of one sensing pixel 100A is still multiple (for example, four), but the number of the lenses 152 in a lens layer 150A is one, such as a giant microlens (GML), and the lens 152 covers the plurality of sensing areas 120, that is, the plurality of sensing areas 120 share one lens 152. There is spacing G1 between the centerline C1 of the lens 152 and the centerline C2 of each of the plurality of first sides A1. In other words, an off-axis design exists between the lens 152 and the plurality of light guide structures 132. When the sensing light L is transmitted to the light guide layer 130, each of the light guide structures 132 may guide the light passing through the first sides A1 to the corresponding second sides A2 via total reflection to be incident on the sensing areas 120, so that the incident light is gathered on the sensing areas 120 as much as possible instead of on the area outside the sensing areas 120, so as to reduce the loss of the sensing light L. In the present embodiment, in the absence of the light guide structure 132, after the sensing light L is converged via the lens 152, a portion of the light is transmitted to the non-sensing areas between the plurality of sensing areas 120, resulting in waste. Via the light guide layer 130 disclosed in the present embodiment, the converged light may be effectively gathered on the sensing areas 120 to improve the efficiency of use of the sensing light L, and further improve the sensing effect of the sensing pixel 100A.

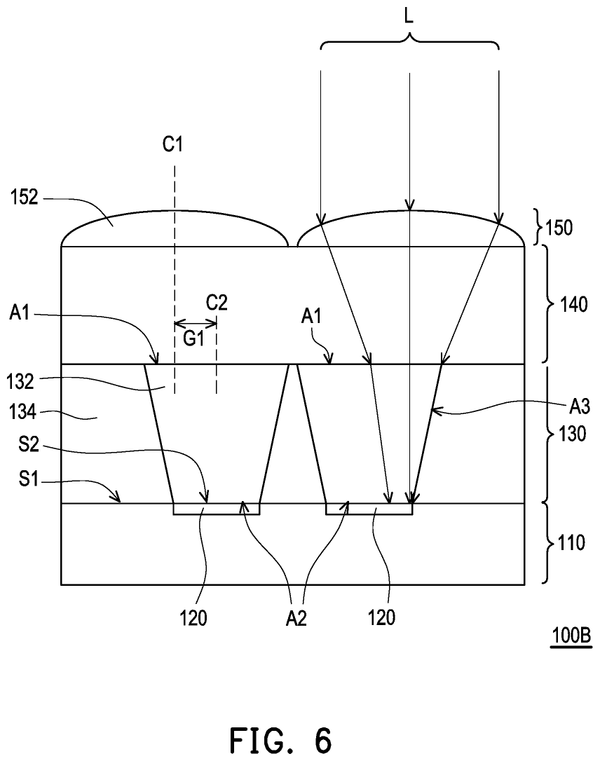

FIG. 6 is a schematic cross-sectional view of a sensing pixel of another embodiment of the invention. Please refer to FIG. 6. A sensing pixel 100B of the present embodiment is similar to the sensing pixel 100 shown in FIG. 3. The difference between the two is that, in the present embodiment, there is spacing between the focal planes of the plurality of lenses 152 and the plurality of first sides A1. The focal planes of the lenses 152 are designed, for example, near the second sides A2 or other positions, and the invention is not limited thereto. Therefore, compared with the focal planes of the lenses 152 overlapped with the first sides A1, the incident angle of the sensing light L from the light transmission layer 140 to the interface of the light guide layer 130 in the present embodiment is smaller. Thus, for the sensing light L passing through the first sides A1 and entering the light guide structures 132, more of the sensing light L may be directly incident on the sensing areas 120, and the angle between another portion of the light transmitted to the sidewalls A3 and the normal lines of the sidewalls A3 is also more likely to be greater than the critical angle to produce total reflection, so that the light is reflected from the sidewalls A3 to the sensing areas 120. Therefore, the loss caused by a lack of total reflection on the sidewalls A3 may be reduced, and the efficiency of use of the sensing light L may be further improved.

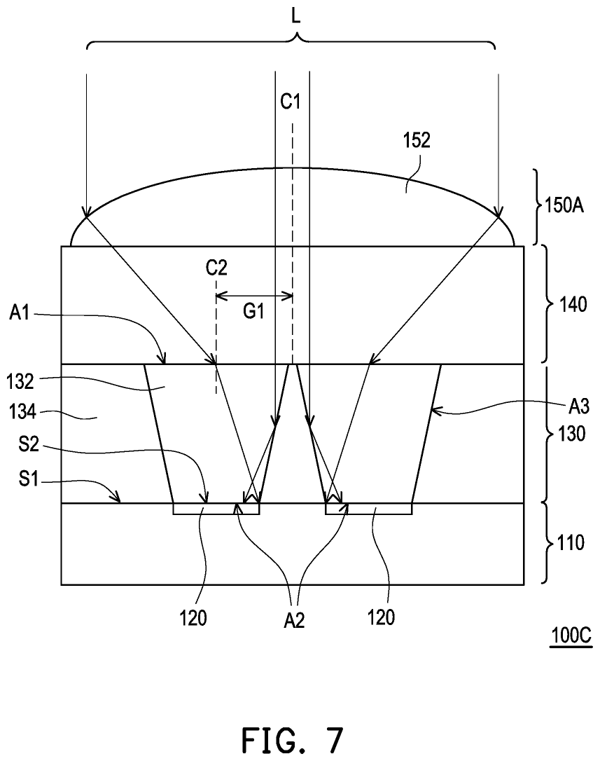

FIG. 7 is a schematic cross-sectional view of a sensing pixel of another embodiment of the invention. Please refer to FIG. 7. A sensing pixel 100C of the present embodiment is similar to the sensing pixel 100A shown in FIG. 5. The difference between the two is that, in the present embodiment, there is spacing between the focal plane of the lens 152 and the plurality of first sides A1. The focal plane of the lens 152 is designed, for example, near the second sides A2 or other positions, and the invention is not limited thereto. When the sensing light L is transmitted to the plurality of light guide structures 132 in the light guide layer 130, compared with the sensing pixel shown in FIG. 5, light loss caused by the lack of total reflection on the sidewalls A3 may be reduced, thereby improving the efficiency of use of the sensing light L. Relevant principles are explained in the above paragraphs, and are not repeated herein. In this way, the sensing light L may be gathered more on the sensing areas 120 instead of on the clearance or circuit area outside the sensing areas 120, thereby reducing the loss of the sensing light L to increase the light collection efficiency and improve the efficiency of use of the sensing light L, and thereby improve the sensing effect of the sensing pixel 100C.

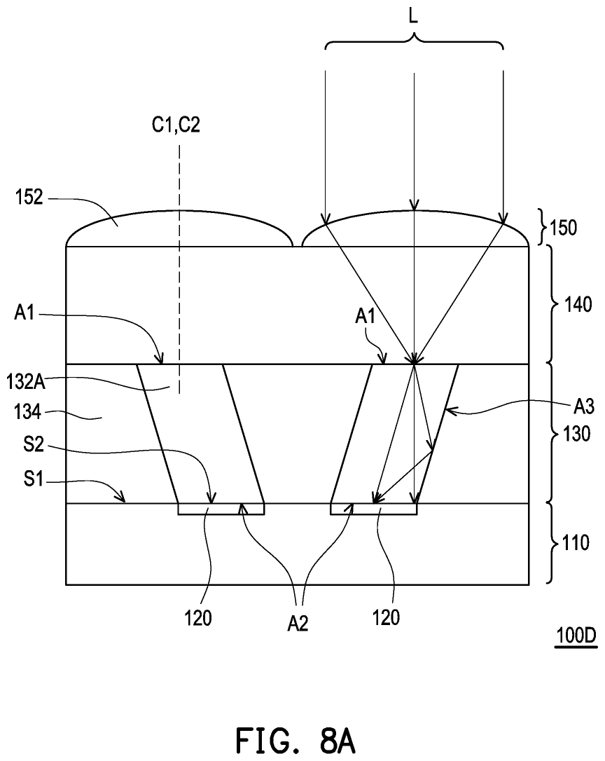

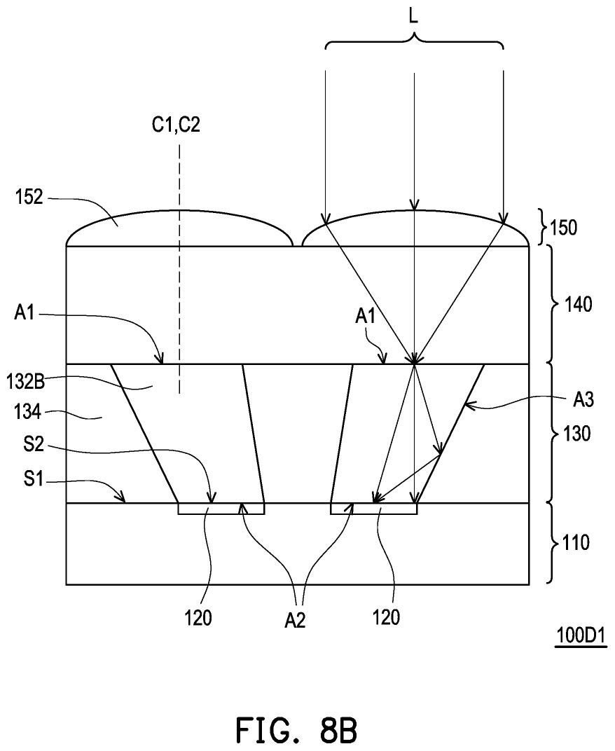

FIG. 8A is a schematic cross-sectional view of a sensing pixel of another embodiment of the invention. Please refer to FIG. 8A. A sensing pixel 100D of the present embodiment is similar to the sensing pixel 100 shown in FIG. 3. The difference between the two is that in the present embodiment, the orthographic projections of the second sides A2 of a plurality of light guide structures 132A on the second substrate 110 are only partially overlapped with the orthographic projections of the first sides A1 of the plurality of light guide structures 132A on the second substrate 110. In addition, the centerline C1 of each of the plurality of lenses 152 is overlapped with the centerline C2 of each of the plurality of first sides A1. In the present embodiment, the area of the first sides A1 of the plurality of light guide structures 132A is equal to the area of the second sides A2. In terms of longitudinal section, the plurality of light guide structures 132A present a parallelogram. Therefore, when the sensing light L is transmitted toward the plurality of light guide structures 132A through the plurality of lenses 152, since the first sides A1 are center-aligned with the lenses 152, the sensing light L converged by the lenses 152 may be more readily transmitted into the plurality of light guide structures 132A, and the light may be guided toward the second sides A2 that is not aligned with the lenses 152 and then incident on the sensing areas 120. In this way, the sensing light L may be gathered more on the sensing areas 120, thus increasing the light collection and sensing effect of the sensing pixel 100D.

In a different embodiment, the longitudinal-section of the light guide structures 132A still presents a parallelogram, but the first sides A1 thereof do not need to be center-aligned with the lenses 152 so as to make the sensing light L more likely to be totally reflected in the light guide structures 132A according to requirements. In other embodiments, the sensing pixel 100D may also be configured similarly to that shown in FIG. 6, so that there is spacing between the focal planes of the lenses 152 and the plurality of first sides A1 of the light guide structure 132A. Or in another embodiment, the sensing pixel 100D may be further configured as shown in FIG. 5 or FIG. 7, in which one lens 152A in the lens layer 150 covers the plurality of sensing areas 120 in the sensing pixel 100D. The invention does not limit the above changes.

FIG. 8B is a schematic diagram of a sensing pixel of another embodiment of the invention. Please refer to FIG. 8B. A sensing pixel 100D1 of the present embodiment is similar to the sensing pixel 100D shown in FIG. 8A. The difference between the two is, in the present embodiment, the area of the first sides A1 of a plurality of light guide structures 132B is greater than the area of the second sides A2. In terms of longitudinal section, the plurality of light guide structures 132B present an inverted trapezoid, and one of the two included angles formed by the second sides A2 and the sidewalls A3 of the inverted trapezoid may be an acute angle (as shown in FIG. 8B) to better facilitate producing a total reflection effect. Therefore, compared with the sensing pixel 100D of the embodiment of FIG. 8A, the present embodiment may make it easier for the sensing light L to pass into the plurality of light guide structures 132B. In this way, the sensing light L may be gathered more on the sensing areas 120 instead of on the clearance or circuit area outside the sensing areas 120, thereby reducing the loss of the sensing light L to increase the light collection efficiency and improve the efficiency of use of the sensing light L, and thereby improve the sensing effect of the sensing pixel 100D1.

In a different embodiment, the light guide structures 132B are inverted trapezoids, but the first sides A1 thereof may be not center-aligned with the lenses 152. For example, the area of the first sides A1 is further expanded outwards so as to receive more of the sensing light L. In other embodiments, the sensing pixel 100D1 may also be configured similarly to that shown in FIG. 6, so that there is spacing between the focal planes of the lenses 152 and the plurality of first sides A1 of the light guide structures 132B. Or in another embodiment, the sensing pixel 100D1 may be further configured as shown in FIG. 5 or FIG. 7, in which one lens 152A in the lens layer 150 covers the plurality of sensing areas 120 in the sensing pixel 100D1. The invention does not limit the above changes.

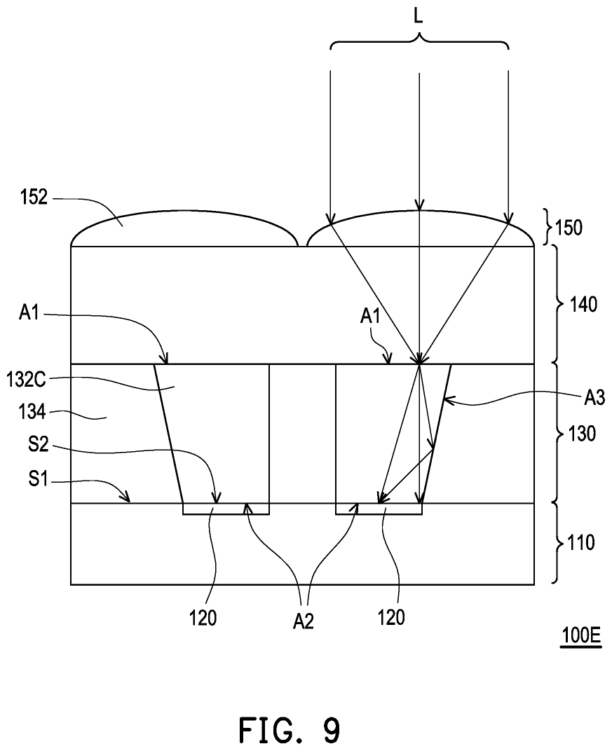

FIG. 9 is a schematic diagram of a sensing pixel of another embodiment of the invention. Please refer to FIG. 9. A sensing pixel 100E of the present embodiment is similar to the sensing pixel 100 shown in FIG. 3. The difference between the two is that, in the present embodiment, a portion of the sidewalls A3 of the plurality of light guide structures 132C facing adjacent light guide structures 132C is designed to be vertical. That is, the sidewall A3 of each of the plurality of light guide structures 132C close to the center of the sensing pixel 100E is a vertical plane. In this way, in addition to further increasing the efficiency of use of the sensing light L, thereby improving the sensing effect of the sensing pixel 100D, the difficulty of the manufacturing process may also be reduced to improve yield.

In a different embodiment, the area and position of the first sides A1 of the light guide structures 132C may be set so that the first sides A1 are center-aligned with the lenses 152. In addition, in other embodiments, the sensing pixel 100E may also be configured similarly to that shown in FIG. 6, so that there is spacing between the focal planes of the lenses 152 and the plurality of first sides A1 of the light guide structures 132C. Or in another embodiment, the sensing pixel 100E may be further configured as shown in FIG. 5 or FIG. 7, in which one lens 152A in the lens layer 150 covers the plurality of sensing areas 120 in the sensing pixel 100E. The invention is not limited in this regard.

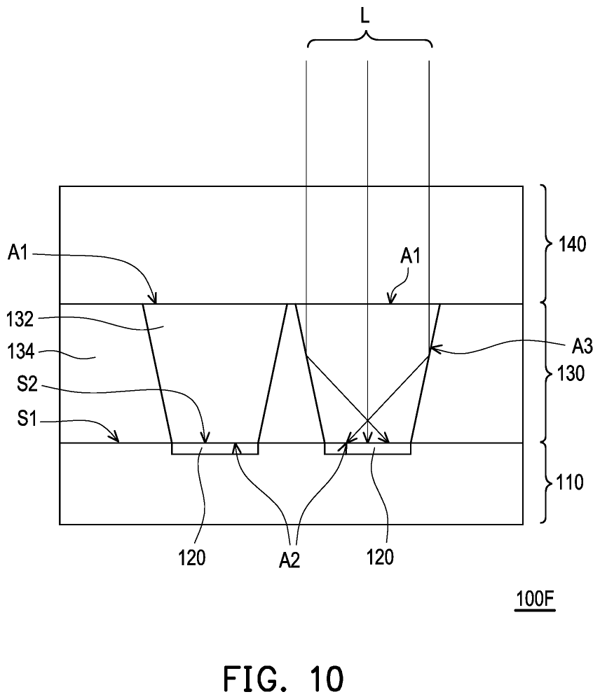

FIG. 10 is a schematic diagram of a sensing pixel of another embodiment of the invention. Please refer to FIG. 10. A sensing pixel 100F of the present embodiment is similar to the sensing pixel 100 shown in FIG. 3. The difference between the two is that in the present embodiment, the lens layer 150 is omitted, and therefore the sensing pixel 100F is suitable for different requirements. For example, the sensing pixel 100F may be disposed in a thin photosensitive device. It is worth mentioning that the lens layer 150 in all the above embodiments may also be omitted as shown in FIG. 10 to form different embodiments, and the invention is not limited thereto. A sensing pixel omitting the lens layer may still transmit the sensing light L passing through the first sides A1 to the sensing areas 120 via the structure of the light guide layer in each of the above embodiments, so as to achieve the effect of improving light collection efficiency. Specifically, in the sensing light L passing through the first sides A1, a portion of the light may be directly transmitted to the second sides A2 and be incident on the sensing areas 120, and another portion of the light may be totally reflected by the sidewall s A3 and then transmitted to the second sides A2 and incident on the sensing areas 120. Moreover, omitting the lens layer may reduce the overall height of the sensing pixel, which is suitable for a thin photosensitive module with stricter requirements on the height of the sensing pixel; in addition, advantages such as easier manufacture and lower costs are achieved.

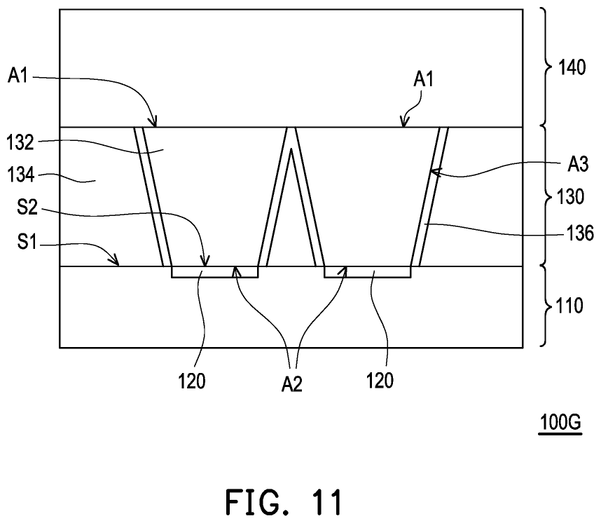

FIG. 11 is a schematic diagram of a sensing pixel of another embodiment of the invention. Please refer to FIG. 11. A sensing pixel 100G of the present embodiment is similar to the sensing pixel 100F shown in FIG. 10. The difference between the two is that, in the present embodiment, the light guide layer 130 further includes reflective interfaces 136 disposed at the plurality of sidewalls A3 of the plurality of light guide structures 132. In other words, the reflective interfaces 136 in the light guide layer 130 are disposed between each of the light guide structures 132 and the medium structure 134. For example, the reflective interfaces 136 are metal. Therefore, by disposing the reflective interfaces 136 facilitating reflection of the sensing light, the reflection effect of the sensing light L in the plurality of light guide structures 132 may be further improved. In the light guide layer 130 in all the above embodiments, the reflective interfaces 136 as shown in FIG. 11 may also be disposed at the sidewalls A3 of the light guide structures 132 to further improve the effect of the sensing light L incident on the sensing areas 120 via the light guide structures 132.

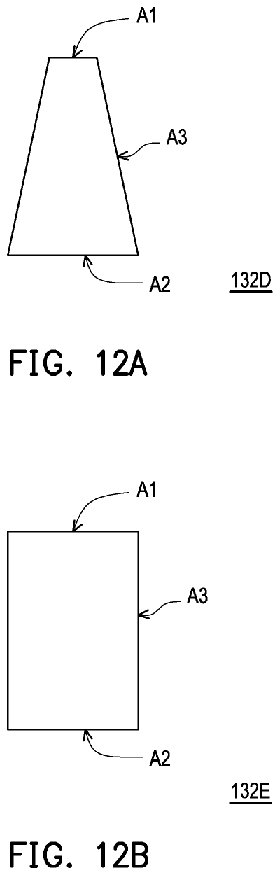

FIG. 12A and FIG. 12B are respectively schematic cross-sectional views of light guide structures of different embodiments of the invention. Please refer to FIG. 12A and FIG. 12B. In addition to the light guide structures 132, 132A, 132B, and 132C of the above embodiments, for example, when the lenses are center-aligned with the first sides A1 and the second sides A2 of the corresponding light guide structures, the light guide structures may also be designed as frustum polygonal pyramids (such as a light guide structure 132D shown in FIG. 12A) for which the first side A1 is less than the second side A2 or a columnar body (such as a light guide structure 132E shown in FIG. 12B) for which the first side A1 and the second side A2 are equal and the projections thereof are completely overlapped, in order to use the light guide structures 132D and 132E to guide or reflect the sensing light from outside the sensing pixel to the corresponding sensing areas, but the invention is not limited thereto.

Based on the above, in the distance sensing module of the invention, the emitting end of the distance sensing module includes the light-emitting unit and the at least one sensing pixel of the receiving end. In particular, the sensing pixel includes the second substrate, the plurality of sensing areas, the light guide layer, the light transmission layer, and the lens layer. The light guide layer includes the plurality of light guide structures, so that when the sensing light is transmitted to the plurality of light guide structures in the light guide layer, the sensing light may be gathered on the sensing areas via the principle of total reflection, thus further reducing the loss of the sensing light. In this way, the amount of received light may be increased to improve the efficiency of use of the sensing light, thereby improving the sensing effect of the distance sensing module.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A distance sensing module, comprising:
a first substrate;
an upper cover disposed on the first substrate to form an accommodating space;
a light-emitting unit disposed at an emitting end in the accommodating space; and
at least one sensing pixel disposed at a receiving end in the accommodating space, and the at least one sensing pixel comprises:
a second substrate disposed in the accommodating space and having a top surface;
a plurality of sensing areas disposed in the second substrate and exposed on the top surface;
a light guide layer disposed on the second substrate, wherein the light guide layer comprises a plurality of light guide structures, each of the plurality of light guide structures has a first side and a second side opposite to each other, and the plurality of second sides are coupled to the plurality of sensing areas;
a light transmission layer disposed on the light guide layer, wherein the light guide layer is located between the second substrate and the light transmission layer, and the plurality of first sides are connected to the light transmission layer; and
a lens layer comprising at least one lens and disposed on the light transmission layer, and the light transmission layer is located between the light guide layer and the lens layer.

2. The distance sensing module of claim 1, wherein the light guide layer further comprises a medium structure surrounding the plurality of light guide structures, and a refractive index of the plurality of light guide structures is greater than a refractive index of the medium structure.

3. The distance sensing module of claim 1, wherein an area of the first side is greater than or equal to an area of the second side.

4. The distance sensing module of claim 1, wherein an orthographic projection of the second side on the second substrate is completely overlapped with an orthographic projection of the first side on the second substrate.

5. The distance sensing module of claim 4, wherein a center of the orthographic projection of the second side on the second substrate is aligned with a center of the orthographic projection of the first side on the second substrate.

6. The distance sensing module of claim 1, wherein an orthographic projection of the second side on the second substrate is only partially overlapped with an orthographic projection of the first side on the second substrate.

7. The distance sensing module of claim 1, wherein a shape of the plurality of light guide structures is a frustum polygonal pyramid or a frustum cone.

8. The distance sensing module of claim 1, wherein each of the plurality of light guide structures further has at least one sidewall connected to the first side and the second side, the light guide layer further comprises a reflective interface disposed at the plurality of sidewalls of the plurality of light guide structures, and the reflective interface is a metal or an air layer.

9. The distance sensing module of claim 1, wherein a focal plane of the at least one lens is overlapped with the plurality of first sides.

10. The distance sensing module of claim 1, wherein there is spacing between a focal plane of the at least one lens and the plurality of first sides.

11. The distance sensing module of claim 1, wherein a number of the at least one lens is one and the at least one lens covers the plurality of sensing areas.

12. The distance sensing module of claim 11, wherein there is spacing between a centerline of the lens and a centerline of each of the plurality of first sides.

13. The distance sensing module of claim 1, wherein a number of the at least one lens is equal to a number of the plurality of sensing areas.

14. The distance sensing module of claim 13, wherein there is spacing between a centerline of each of the plurality of lenses and a centerline of each of the plurality of first sides.

15. The distance sensing module of claim 13, wherein a centerline of each of the plurality of lenses is overlapped with a centerline of each of the plurality of first sides.

16. The distance sensing module of claim 15, wherein the centerline of each of the plurality of lenses is overlapped with a centerline of each of the plurality of second sides.

17. The distance sensing module of claim 1, further comprising:
a baffle disposed in the accommodating space to partition the accommodating space into the emitting end and the receiving end.

18. The distance sensing module of claim 1, wherein a number of the at least one sensing pixel is multiple, and the multiple sensing pixels share the same second substrate.
